(19) United States
(12) Patent Application Publication
(10) Pub. No.: US 2009/0135444 A1
(43) Pub. Date: May 28, 2009

(54) METHOD TO PROTECT SENSITIVE DATA FIELDS STORED IN ELECTRONIC DOCUMENTS

(76) Inventors: Steven Francis Best, Georgetown, TX (US); Robert James Eggers, JR., Austin, TX (US); Janice Marie Girouard, Austin, TX (US); David Bruce Kumhyr, Austin, TX (US)

Correspondence Address: IBM CORP (YA);C/O YEE & ASSOCIATES PC, P.O. BOX 802333, DALLAS, TX, 75380, US

(21) Appl. No.: 11/944,674

(22) Filed: Nov. 26, 2007

(51) Int. Cl. G06F 3/12

(52) U.S. Cl. 358/1.15

(57) ABSTRACT

A computer implemented method, a computer program product, and a data processing system control the presentation of sensitive data within a document. A request to open a document is received. Responsive to receiving the request to open the document, sensitive data within the document is identified. Responsive to identifying sensitive data within the document, the occurrence of an expiration date for the sensitive data is identified. Responsive to identifying the occurrence of the expiration date for the sensitive data, the sensitive data is redacted to create an edited document. The edited document is then displayed to the user.

### BACKGROUND OF THE INVENTION

1. Field of the Invention

The present invention relates generally to an improved data processing system, and in particular to a computer implemented method and apparatus for managing information. Still more particularly, the present invention relates to a computer implemented method, apparatus, and computer usable program product for controlling the presentation of sensitive data within a document.

2. Description of the Related Art

Documents, recordings, or other forms of media containing sensitive information may be viewed and stored on a user's computing device, or on a network server. Sensitive information is information that is private, personal, or otherwise unsuitable for dissemination to the public. For example, sensitive information may include trade secrets, user account information, credit card numbers, credit reports, or any other similar type of information.

Sensitive information may be viewed in public areas, such as in a coffee shop, a waiting room, an airport, or on an airplane. In some instances, the viewing of sensitive information is subject to strict company policies or procedures that are ignored because of time constraints, a blatant disregard for procedures, or inattentiveness. Consequently, sensitive information may be inadvertently disseminated to people having malicious intentions. For example, corporate trade secrets may be obtained by competitors, a user's identity may be stolen, or embarrassing details of a user's personal life may be discovered.

Currently used methods for protecting the display of sensitive information include implementing physical components or devices. For example, privacy screens are sometimes applied to laptop monitors or other mobile devices to prevent a third party from viewing information displayed on a laptop monitor. These privacy screens allow only the user sitting directly in front of the laptop to view the presented information. This method, however, does not prevent third parties from viewing the sensitive information if the user steps away from the laptop. Further, use of the privacy screen may give the user a false sense of security, thereby decreasing the user's vigilance against potentially malicious behavior.

Another currently used method for restricting access to sensitive information is to limit the display of information based upon a location of the user. Thus, if the user is in a trusted location, such as the user's office, then the user may access the sensitive content. However, this may be insufficient means of protection. For example, if a user is at the office, a trusted location, but is negotiating a contract with third parties, then sensitive content may still be presented despite the fact that the user is in a trusted location. Furthermore, this method of restricting the presentation of sensitive information may deny a user the ability to receive certain information without exception, even if the receipt of sensitive information is preferred, necessary, or advantageous.

Thus, the currently used methods for limiting the display of sensitive information may not offer sufficient protection against the inadvertent display of sensitive information. Therefore, it would be advantageous to have a method and apparatus to overcome the problems described above.

### SUMMARY OF THE INVENTION

The illustrative embodiments provide a computer implemented method, a computer program product, and a data processing system for controlling the presentation of sensitive data within a document. A request to open a document is received. Responsive to receiving the request to open the document, a determination is made as to whether sensitive data is present within the document. Responsive to determining that sensitive data is present within the document, a determination is made as to whether an expiration date associated with the sensitive data has occurred. Responsive to identifying an occurrence of the expiration date for the sensitive data, the sensitive data is redacted to create an edited document. The edited document is then presented to the user after the sensitive data has been redacted from the document.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of data flow between components in accordance with an illustrative embodiment;

FIG. 4 is a flowchart of a software process for entering sensitive data into a document in accordance with an illustrative embodiment; and

FIG. 5 is a flowchart of a software process for displaying documents containing sensitive data in accordance with an illustrative embodiment.

### DETAILED DESCRIPTION OF THE PREFERRED EMBODIMENT

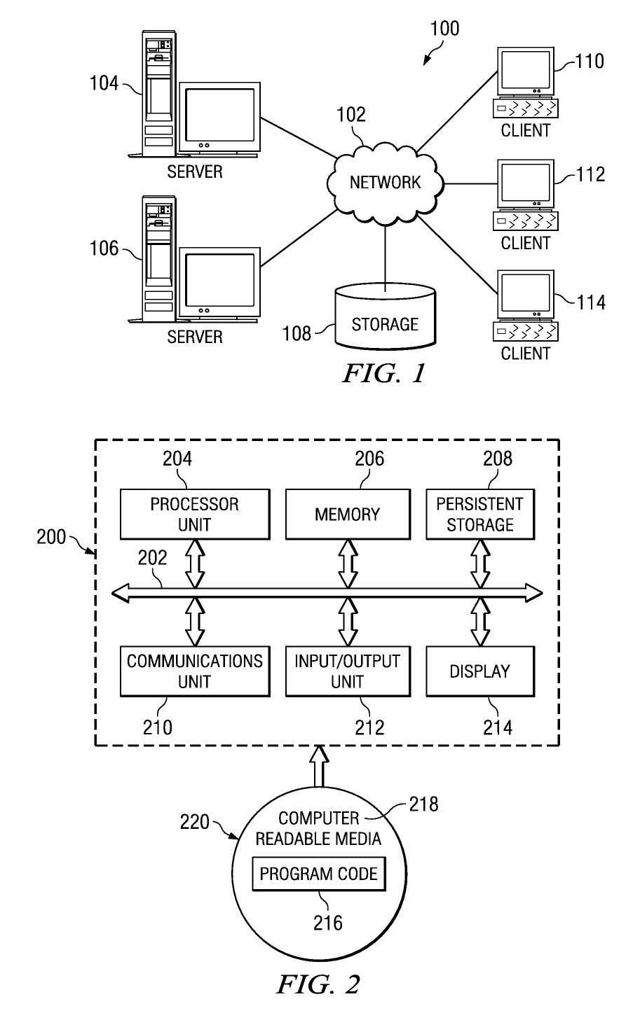

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, client 110, personal digital assistant (PDA) 112, and laptop 114 connect to network 102. Client 110 may be, for example, personal computers or network computers. In the depicted example, server 104 provides data, such as boot files, operating system images, and applications to client 110, personal digital assistant (PDA) 112, and laptop 114. Client 110, personal digital assistant (PDA) 112, and laptop 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

Turning now to FIG. 2, a diagram of a data processing system is depicted in accordance with an illustrative embodiment of the present invention. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as, program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive or a flash memory that is connected to data processing system 200. The tangible form of computer readable media 218 is also referred to as computer recordable storage media.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Responsive to entering data into a document, a user of a client, such as client 110 of FIG. 1, can designate the data as sensitive data. An expiration date, which can be custom, is then associated with the sensitive data. Upon a subsequent viewing of the document, a determination is made as to the occurrence of the expiration date. Responsive to identifying the occurrence of the expiration date, sensitive data is redacted from the document. The user is presented with an edited document that contains only the data that was not designated as sensitive. The document can be stored locally on the client, or can be stored remotely, for example on a server, such as server 104 of FIG. 1.

Using the illustrative embodiments, a user is equipped with improved access control over data fields in a document. Sensitive personal data contained within various documents throughout a file system can be effectively purged of sensitive personal data without the need to individually examine, or delete separate documents. The user is provided with greater control of the entry of personal data into documents, and the storage of personal data therein, that have a temporal usefulness.

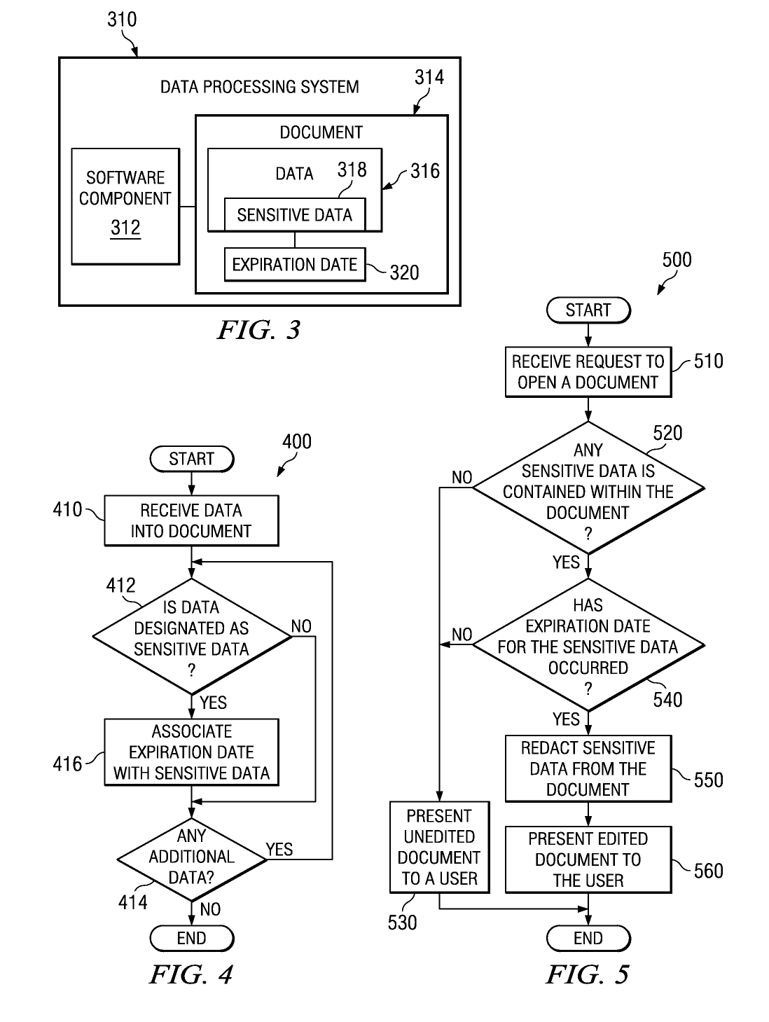

Referring now to FIG. 3, a block diagram of data flow between components is shown in accordance with an illustrative embodiment. Data processing system 310 can be data processing system 200 of FIG. 2.

Software component 312 executes on data processing system 310. Software component 312 is any software capable of creating documents or editing information within a document. Software component 312 can be a spreadsheet program, such as Excel® or Lotus 1-2-3®. Software component 312 can be a word processing program, such as, for example, Word® or Word Perfect®. As another example, software component 312 can also be an email program, such as Outlook® or Eudora®. Word®, Word Perfect®, and Outlook® are trademarks of Microsoft Corporation in the United States, other countries, or both. Lotus 1-2-3® is a trademark of IBM Corporation in the United States, other countries, or both. Eudora® is a trademark of Qualcomm, Inc. in the United States, other countries, or both. Additionally, software component 312 may be implemented as a plug-in component that works with another application capable of creating documents or editing information within a document.

Software component 312 accesses document 314. Document 314 is a computer file that contains data that can be accessed by applications, such as software component 312. Document 314 contains data 316.

Data 316 may be designated as sensitive by the author or recipient of data 316. This designation forms sensitive data 318. For example, if data 316 is a document, spreadsheet, presentation, email, web page, instant message, voice recording, video, or similar form of communication, then the author of the communication may designate a portion of data 316 as sensitive to form sensitive data 318. The portion of sensitive data 318 may be, for example, a paragraph, a slide, a sentence, a word, or a particular message. When using software component 312 to generate document 314, software component 312 may provide the user with a selectable menu option from a graphical user interface to designate a portion of data 316 as sensitive data 318. Alternatively, the graphical user interface may be operable by a user to designate portions of data 316 as sensitive data 318 when document 314 is created by an ancillary program. Sensitive data 318 can be a portion of data 316. Sensitive data 318 can also be the entirety of data 316.

Sensitive data 318 can be, for example, personal information, including without limitation, bank accounts, social security numbers, driver's license numbers, telephone numbers, e-mail addresses, home addresses, or personal passwords. Sensitive data 318 can similarly be enterprise information, including without limitation, stock information, shareholder minutes, or accounting information.

By choosing to designate a portion of data 316 as sensitive data 318 from the graphical user interface, a data marking process is initiated. The data marking process is a software process executing on software component 312. The data marking process designates data, such as data 316, as sensitive data, such as sensitive data 318. The data marking process also associates an expiration date, such as expiration date 320, with the data marked as sensitive data.

Responsive to designating sensitive data 318, a user can associate expiration date 320 with sensitive data 318. Expiration date 320 defines a time period during which sensitive data 318 is viewable within document 314. Without limitation, expiration date 320 can be a set calendar date or time, such as 14:00:00 Feb. 19, 2000. Expiration date 320 can also be a defined time interval defining the elapse of a set amount of time. Expiration date 320 can also be the occurrence of an event, such as a predefined number of viewings of document 314.

Upon the occurrence of expiration date 320, a data redaction process redacts sensitive data 318 from document 314 before document 314 is presented. The data redaction process is a software process executing on software component 312. The data redaction process redacts data sensitive data, such as sensitive data 318, from the document upon the occurrence of the expiration date, such as expiration date 320. Document 314 is left containing only data 316 that was not designated as sensitive data 318, and sensitive data 318 that has an expiration data that has occurred, such as expiration date 320. Software component 312 may redact sensitive data 318 from document 314 by removing sensitive data 318 from document 314 by blacking out, or otherwise obscuring, sensitive data 318, or by replacing sensitive data 318 with non-sensitive content.

In the different illustrative examples, obscuring sensitive data 318 means altering the appearance of sensitive data 318 so that it cannot be read. For example, blurring out sensitive data 318 so that this data cannot be read or viewed is one method that may be used to obscure sensitive data 318. Replacing sensitive data 318 with non-sensitive content, on the other hand, may also be utilized to obscure sensitive data 318. Non-sensitive content can be a statement such as “sensitive” or “redacted” that is used to replace sensitive data 318. Such a statement indicates that sensitive content exists, but does not divulge the substance of sensitive data 318.

Referring now to FIG. 4, a flowchart of a software process for entering sensitive data into a document is depicted in accordance with an illustrative embodiment. Process 400 is a software process, such as the data marking process executing on software component 312 of FIG. 3.

Process 400 begins by receiving data into a document (step 410). The document can be document 314 of FIG. 3. The data can be data 316 of FIG. 3. The document can be, without limitation, a spreadsheet, a word pad, an email, a word processing document, presentation, web page, instant message, voice recording, video, or similar form of communication. Data can be any input by a user into the document.

Process 400 then identifies whether the data has been designated as sensitive data (step 412). When using process 400 to generate the document, process 400 may provide the user with a selectable menu option to designate a portion of the data as sensitive data. Alternatively, process 400 may include a graphical user interface operable by a user to designate portions of data as sensitive data when the document is created by an ancillary program. The Sensitive data can be a portion of data. The Sensitive data can also be the entirety of the data.

Responsive to the data not having been identified as sensitive data (“no” at step 412), process 400 identifies whether any additional data has been entered into the document (step 414). If process 400 identifies that additional data has been entered (“yes” at step 414), process 400 returns to step 412 to identify whether the data has been designated as sensitive data. If process 400 identifies that additional data has not been entered (“no” at step 414), the process terminates.

Returning now to step 412, responsive identifying that the data has been designated as sensitive data, process 400 associates an expiration date with the sensitive data (step 416). The expiration date defines a time period during which the sensitive data is viewable within the document. Without limitation, the expiration date can be a set calendar date or time, such as 14:00:00 Feb. 19, 2000. The expiration date can also be a defined time interval defining the lapse of a set amount of time. The expiration date can also be the occurrence of an event, such as a predefined number of viewings of a document.

Situations may arise where a user would desire that information in a document be unviewable. In this situation, a user may wish to designate an expiration date that has already occurred. In any subsequent viewing of the document, the process would necessarily redact the sensitive information, since the expiration date would have necessarily already occurred.

The expiration date can be defined by the user. For example, a user may specify an expiration date by entering an expiration date at the time process 400 associates an expiration date with the sensitive data. Alternatively, in the absence of a user specified expiration date, process 400 may have a default expiration date which applies to all data designated as sensitive data.

Responsive to associating an expiration date with the sensitive data, process 400 returns to step 414 to determine whether any additional data has been entered into the document. The process can repeat, until no further information has been designated as sensitive.

Using the illustrative embodiments, a user is equipped with improved access control over data fields in a document. Sensitive personal data contained within various documents throughout a file system can be effectively purged of sensitive personal data without the need to individually examine, or delete separate documents. The user is provided with greater control of the entry of personal data into documents, and the storage of personal data therein, that have a temporal usefulness.

Referring now to FIG. 5, a flowchart of a software process for displaying documents containing sensitive data is depicted in accordance with an illustrative embodiment. Process 500 is a software process, such as the data redacting process executing on software component 312 of FIG. 3.

Process 500 begins by receiving a request to open a document (step 510). Responsive to receiving a request to open a document, process 500 identifies whether any sensitive data is contained within the document (step 520).

Process 500 can identify the existence of sensitive data within the document by parsing the document for any data that has been designated as sensitive data. This can be done by searching data within the document for a tag, pointer, flag, bit, or other indicator that identifies the sensitive data within the document. Alternatively, process 500 can identify a flag or other indicator associated with the document itself without parsing the actual text of the document, to determine whether the document contains sensitive data.

Responsive to process 500 not identifying any sensitive data contained within the document (“no” at step 520), process 500 presents the unedited document to a user (step 530), with the process terminating thereafter. Because no sensitive data is contained within the document, all data contained within the document is presented to, and is viewable by, the user.

Returning now to step 520, responsive to process 500 identifying sensitive data contained within the document, process 500 identifies whether the expiration date for the sensitive data has occurred (step 540). The expiration date can be expiration date 320 of FIG. 3. The expiration date defines a time period during which the sensitive data is viewable within the document. Without limitation, the expiration date can be a set calendar date or time, such as 14:00:00 Feb. 19, 2000. The expiration date can also be a defined time duration defining the lapse of a set amount of time. The expiration date can also be the occurrence of an event, such as a predefined number of viewings of the document.

The expiration date can be defined by the user. For example, a user may specify an expiration date by entering an expiration date at the time process 500 associates an expiration date with the sensitive data. Alternatively, in the absence of a user specified expiration date, process 500 may have a default expiration date which applies to all data designated as sensitive data.

Responsive to determining that the expiration date has not occurred (“no” at step 540), process 500 returns to step 530, and presents the unedited document to a user (step 530), with the process terminating thereafter. Because the sensitive data contained within the document has not yet expired, all data contained within the document, including the sensitive data, is presented to, and is viewable by, the user.

Returning now to step 540, responsive to determining that the expiration date has occurred (“yes” at step 540), process 500 redacts the sensitive data from the document (step 550). The document is left containing only the data that was not designated as sensitive data. Process 500 may redact the sensitive data from the document by removing sensitive data from the document by blacking out, or otherwise obscuring sensitive data, or by replacing the sensitive data with non-sensitive content. Responsive to redacting the sensitive data from the document, process 500 presents the edited document to a user (step 560), with the process terminating thereafter. Because sensitive data is contained within the document, only the data contained within the document that was not identified as sensitive data is presented to, and is viewable by, the user. The document is left containing only the data that was not designated as sensitive data. Having been redacted from the document, sensitive data is not viewable by the user.

Thus, the illustrative embodiments described herein provide a computer implemented method, apparatus, and computer usable program product for controlling the presentation of information. Responsive to entering data into a document, a user can designate the data as sensitive data. An expiration date, which can be custom, is then associated with the sensitive data. Upon a subsequent viewing of the document, a determination is made as to the occurrence of the expiration date. Responsive to identifying the occurrence of the expiration date, sensitive data is redacted from the document. The user is presented with an edited document that contains only the data that was not designated as sensitive.

Using the illustrative embodiments, a user is equipped with improved access control over data fields in a document. Sensitive personal data contained within various documents throughout a file system can be effectively purged of sensitive personal data without the need to individually examine, or delete separate documents. The user is provided with greater control of the entry of personal data into documents, and the storage of personal data therein, that have a temporal usefulness.

The invention can take the form of an entirely hardware embodiment, an entirely software embodiment or an embodiment containing both hardware and software elements. In a preferred embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for controlling the presentation of sensitive data within a document, the method comprising:
receiving a request to open a document;
responsive to receiving the request to open the document, determining whether sensitive data is present within the document;
responsive to a determination that the sensitive data is present within the document, determining whether an expiration date has occurred for the sensitive data;
responsive to identifying an occurrence of the expiration date for the sensitive data, redacting the sensitive data from the document to create an edited document; and
presenting the edited document after the sensitive data has been redacted from the document.

2. The computer implemented method of claim 1, wherein the step of identifying sensitive data within the document comprises:
determining whether a flag is associated with the document to indicate whether the document contains sensitive data.

3. The computer implemented method of claim 1, wherein the step of determining whether sensitive data is present within the document comprises:
parsing the document for at least one of a tag, a pointer, a flag, and a bit associated with text of the document to identify whether the document contains sensitive data

4. The computer implemented method of claim 1, wherein the expiration date is selected from one of a custom expiration date and a default expiration date.

5. The computer implemented method of claim 1, wherein the expiration date is one of a set calendar date, a set calendar time, a lapse of a set time duration, or the occurrence of an event.

6. The computer implemented method of claim 5, wherein the occurrence of the event is a predefined number of viewings of the document.

7. The computer implemented method of claim 1, wherein the step of redacting the sensitive data from the document to create an edited document is one of by blacking out the sensitive data, obscuring the sensitive data, blurring out the sensitive data, and replacing the sensitive data with non-sensitive content.

8. A computer program product comprising:
a computer readable medium having computer usable program code for transferring data between virtual partitions, the computer program product comprising:
computer usable program code for receiving a request to open a document;
computer usable program code, responsive to receiving the request to open the document, for determining whether sensitive data is present within the document;
computer usable program code, responsive to a determination that the sensitive data is present within the document, for determining whether an expiration date has occurred for the sensitive data;
computer usable program code, responsive to identifying an occurrence of the expiration date for the sensitive data, for redacting the sensitive data from the document to create an edited document; and
computer usable program code for presenting the edited document after the sensitive data has been redacted from the document.

9. The computer program product of claim 8, wherein the computer usable program code for identifying sensitive data within the document comprises:
computer usable program code for determining whether a flag is associated with the document to indicate whether the document contains sensitive data.

10. The computer program product of claim 8, wherein the computer usable program code for determining whether sensitive data is present within the document comprises:
computer usable program code for parsing the document for at least one of a tag, a pointer, a flag, and a bit associated with text of the document to identify whether the document contains sensitive data.

11. The computer program product of claim 8, wherein the expiration date is selected from one of a custom expiration date, and a default expiration date.

12. The computer program product of claim 8, wherein the expiration date is one of a set calendar date, a set calendar time, a lapse of a set time duration, or the occurrence of an event.

13. The computer program product of claim 12, wherein the occurrence of the event is a predefined number of viewings of the document.

14. The computer program product of claim 8, wherein computer usable program code for redacting the sensitive data from the document to create an edited document is one of computer usable program code for blacking out the sensitive data, computer usable program code for obscuring the sensitive data, computer usable program code for blurring out the sensitive data, and computer usable program code for replacing the sensitive data with non-sensitive content.

15. A data processing system comprising:
a bus;
a communications unit connected to the bus;
a storage device connected to the bus, wherein the storage device includes computer usable program code; and
a processor unit connected to the bus, wherein the processor unit executes the computer usable program code to receive a request to open a document, responsive to receiving the request to open the document, determine whether sensitive data is present within the document, responsive to a determination that the sensitive data is present within the document, determine whether an expiration date has occurred for the sensitive data, responsive to identifying an occurrence of the expiration date for the sensitive data, redact the sensitive data from the document to create an edited document, and present the edited document after the sensitive data has been redacted from the document.

16. The data processing system of claim 15, wherein the computer usable program code to identify sensitive data within the document comprises:
computer usable program code to determine whether a flag is associated with the document to indicate whether the document contains sensitive data.

17. The data processing system of claim 15, wherein the computer usable program code to determining whether sensitive data is present within the document comprises:
computer usable program code to parse the document for at least one of a tag, a pointer, a flag, and a bit associated with text of the document to identify whether the document contains sensitive data.

18. The data processing system of claim 15, wherein the expiration date is selected from one of a custom expiration date, and a default expiration date.

19. The data processing system of claim 15, wherein the expiration date is one of a set calendar date, a set calendar time, an elapse of a set time duration, or the occurrence of an event.

20. An apparatus comprising:
a data marking process for marking data within a document as sensitive data;
a data redaction process for redacting data from the document upon the occurrence of an expiration date associated with the sensitive data; and
a user interface for identifying a user indication of the sensitive data and identifying a user indication of the expiration date, wherein the data marking process, the data redaction process and the user interface are software components executing on a processor.
